(19) United States
(12) Patent Application Publication
(10) Pub. No.: US 2023/0365748 A1
(43) Pub. Date: Nov. 16, 2023

(54) CATALYST PARTICLES FOR POLYESTER PRODUCTION AND METHOD FOR PRODUCING POLYESTER USING SAME

(71) Applicant: TEIJIN LIMITED, Osaka (JP)

(72) Inventors: Shuto ISHII, Osaka (JP); Fuminori TAKENAGA, Osaka (JP)

(73) Assignee: TEIJIN LIMITED, Osaka (JP)

(21) Appl. No.: 18/030,111

(22) PCT Filed: Sep. 27, 2021
(86) PCT No.: PCT/JP2021/035407

§ 371 Date: Apr. 4, 2023

(30) Foreign Application Priority Data
Oct. 6, 2020 (JP) 2020-169204

(51) Int. Cl. C08G 63/85; C08K 5/13

(52) U.S. Cl. CPC C08G 63/85; C08K 5/13

(57) ABSTRACT

The present invention provides: catalyst particles for use in producing a polyester which has a satisfactory color tone and, after having been molded, has satisfactory transparency (low haze); and a method for producing a polyester using the catalyst particles. The catalyst particles for polyester production according to the present invention comprise a product of reaction between the following titanium compound ingredient (A) and the following phosphorus compound ingredient (B) and have a particle diameter D₅₀ of 10.0 or smaller and a particle diameter D₉₀ of 20.0 μm or smaller. Ingredient (A): A titanium compound ingredient comprising at least one compound selected from among titanium compounds (1) represented by formula (I) and titanium compounds (2) each obtained by reacting any of the titanium compounds of general formula (I) with either an aromatic polycarboxylic acid represented by general formula (II) or an anhydride thereof. Ingredient (B): A phosphorus compound ingredient comprising at least one phosphorus compound (3) represented by general formula (III).

### FIELD

The present invention relates to a catalyst particle for polyester production and a method for producing a polyester by use of the catalyst particle. More specifically, the present invention relates to a catalyst particle for polyester production, comprising specific titanium compound and phosphorus compound, and a method for producing a polyester that has a favorable color tone and that is favorable in transparency (low in haze) after molding, by use of the catalyst particle.

### BACKGROUND

Polyesters, in particular, polyethylene terephthalate, polyethylene naphthalate, polytrimethylene terephthalate and polytetramethylene terephthalate, are excellent in mechanical, physical, and chemical performances, and thus are widely utilized in fibers, films, and other molded products.

For example, a generally known methods for producing polyethylene terephthalate is a method in which a reaction product containing an ester of terephthalic acid with ethylene glycol, and/or its low polymer, is prepared by direct esterification reaction of terephthalic acid and ethylene glycol, transesterification reaction of a lower alkyl ester of terephthalic acid, such as dimethyl terephthalate, and ethylene glycol, or reaction of terephthalic acid and ethylene oxide, and the reaction product is subjected to heating and polycondensation reaction in the presence of a polymerization catalyst under reduced pressure until a predetermined degree of polymerization is achieved. Polyethylene naphthalate, polytrimethylene terephthalate, and polytetramethylene terephthalate are also produced by the same method as described above.

It is well known with respect to the polycondensation reaction that the reaction rate and the quality of a polyester obtained largely depend on the type of the catalyst used. Antimony compounds are most widely used as polycondensation catalysts of polyethylene terephthalate. Antimony compound catalysts have excellent polycondensation catalyst performance and polyesters obtained with such catalysts are favorable in color tone.

However, in the case of use of antimony compounds as polycondensation catalysts, a problem is that, if polyesters obtained are continuously melt-spun for long periods of time, foreign matter (hereinafter, sometimes referred to as “spinneret foreign matter”) is attached and deposited around spinneret holes for melt-spinning, to thereby lead to the occurrence of a bending phenomenon (bending) of molten polymer flow extruded through spinnerets, and this phenomenon causes the occurrence of fluffing, breakage and/or the like of fiber yarns obtained in spinning and/or stretching step(s). There is also proposed use of titanium compounds, for example, titanium tetra-butoxide, as polycondensation catalysts other than the antimony compounds. Use of such titanium compounds, although can solve the above problem of deposition of spinneret foreign matter, causes new problems including yellow coloring of polyesters obtained, by themselves, and also poor melt heat stability.

In order to solve the above problem of coloration, suppression of yellowness by addition of cobalt compounds as color tone adjusters to polyesters is commonly performed. Although addition of cobalt compounds can certainly allow for improvements in color tones (b values) of polyesters, addition of cobalt compounds causes the problem of deterioration in melt heat stability of polyesters and thus easy polymer decomposition.

With respect to other titanium compounds, PTL 1 discloses use of titanium hydroxide as a catalyst for polyester production, and PTL 2 discloses use of α-titanic acid as a catalyst for polyester production. However, the former use has a difficulty in forming titanium hydroxide into a powder, and on the other hand, the latter use has a difficulty in storing and handling α-titanic acid because α-titanic acid is easily denatured. Accordingly, both the catalysts are not suitable for industrial application, and furthermore a polymer favorable in color tone (b value) is difficult to obtain by use of such a catalyst.

PTL 3 describes use of a product obtained by reaction of a titanium compound and trimellitic acid, as a catalyst for polyester production, and PTL 4 discloses use of a product obtained by reaction of a titanium compound and a phosphorus acid ester, as a catalyst for polyester production. Such use certainly results in a certain enhancement in melt heat stability of a polyester, but the color tone of a polyester obtained is not sufficient. Accordingly, there is a demand for a further improvement in color tone of a polyester.

Furthermore, PTL 5 proposes a complex of a titanium compound and a phosphorus compound, adopted as a catalyst for polyester production, and such use results in a certain enhancement in melt heat stability, but the color tone of a polymer obtained cannot be satisfiable.

PTL 6 proposes a catalyst for polyester production, comprising a reaction product of specific titanium compound and phosphorus compound, but such a catalyst causes an insufficient transparency after molding of a polyester obtained, and an improvement in such a transparency is demanded.

### CITATION LIST

### Patent Literature

[PTL 1] Japanese Examined Patent Publication (Kokoku) No. S48-2229

[PTL 2] Japanese Examined Patent Publication (Kokoku) No. S47-26597

[PTL 3] Japanese Examined Patent Publication (Kokoku) No. S59-46258

[PTL 4] Japanese Unexamined Patent Publication (Kokai) No. S58-38722

[PTL 5] Japanese Unexamined Patent Publication (Kokai) No. H7-138354

[PTL 6] WO2003/008479

### SUMMARY

### Technical Problem

An object of the present invention is to provide a catalyst particle for production of a polyester that has a favorable color tone and that is favorable in transparency (low in haze) after molding, and a method for producing a polyester by use of the catalyst particle.

### Solution to Problem

The above object is achieved by the catalyst particle for polyester production and the method for producing a polyester by use of the catalyst particle, of the present invention, according to the following Aspects.

### <<Aspect 1>>

A catalyst particle for polyester production, comprising a reaction product of the following titanium compound component (A) and phosphorus compound component (B), wherein
a particle size D50 is 10.0 μm or less, and
a particle size D90 is 20.0 μm or less:

(A) a titanium compound component consisting of at least one selected from
a titanium compound (1) represented by the following general formula (I), and
a titanium compound (2) obtained by reaction of the titanium compound (1) of the general formula (I) and an aromatic polyvalent carboxylic acid represented by the following general formula (II), or its anhydride:

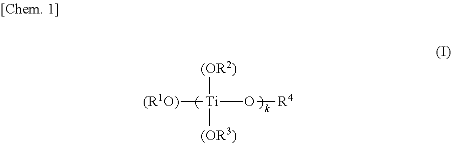

wherein R¹, R², R³ and R⁴ in the formula (I) each mutually independently represent an alkyl group having 2 to 10 carbon atoms, k represents an integer of 1 to 3, and when k represents 2 to 3, two or three R² groups and R³ groups are each optionally mutually the same or different,

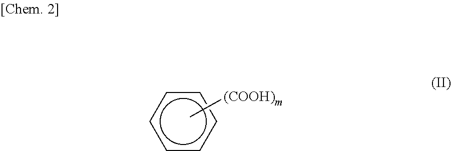

wherein in in the formula (II) represents an integer of 2 to 4;

(B) a phosphorus compound component consisting of at least one phosphorus compound (3) represented by the following general formula (III):

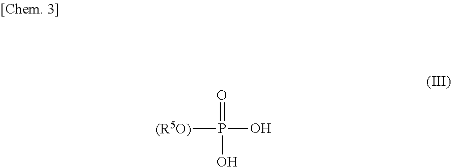

wherein R⁵ in the formula (III) represents an unsubstituted or substituted, aryl group having 6 to carbon atoms or alkyl group having 1 to 20 carbon atoms.

### <<Aspect 2>>

The catalyst particle for polyester production according to Aspect 1, wherein a reaction molar ratio (m_{Ti}/m_{P}) of a molar amount in terms of titanium atom (m_{Ti}) of the titanium compound component (A) to a molar amount in terms of phosphorus atom (m_{P}) of the phosphorus compound component (B), in the reaction product of the titanium compound component (A) and the phosphorus compound component (B), is in the range from 1:1 to 1:3.

### <<Aspect 3>>

The catalyst particle for polyester production according to Aspect 1 or 2, wherein the titanium compound (1) of the formula (I) is selected from a titanium tetra-alkoxide compound, an octaalkyl trititanate compound, and a hexaalkyl dititanate compound.

<<Aspect 4>>

The catalyst particle for polyester production according to any of Aspects 1 to 3, wherein the aromatic polyvalent carboxylic acid of the formula (II), or its anhydride is selected from phthalic acid, trimellitic acid, hemimellitic acid, and pyromellitic acid, or their anhydrides.

### <Aspect 5>>

The catalyst particle for polyester production according to any of Aspects 1 to 4, wherein the titanium compound (2) is a reaction product of the titanium compound (1) of the formula (I) and the aromatic polyvalent carboxylic acid of the formula (ii), or its anhydride, at a reaction molar ratio of 2:1 to 2:5.

### <<Aspect 6>>

The catalyst particle for polyester production according to any of Aspects 1 to 5, wherein the phosphorus compound (3) of the formula (ill) is at least one selected from monomethyl phosphate, monoethyl phosphate, monotrimethyl phosphate, mono-n-butyl phosphate, monohexyl phosphate, monoheptyl phosphate, monooctyl phosphate, monononyl phosphate, monodecyl phosphate, monododecyl phosphate, monolauryl phosphate, monooleyl phosphate, monotetradecyl phosphate, monophenyl phosphate, monobenzyl phosphate, mono(4-dodecyl)phenyl phosphate, mono(4-methylphenyl)phosphate, mono(4-ethylphenyl)phosphate, mono(4-propylphenyl)phosphate, mono(4-dodecylphenyl)phosphate, monotolyl phosphate, monoxylyl phosphate, monohiphenyl phosphate, mononaphthyl phosphate, and monoanthryl phosphate.

### <<Aspect 7>>

The catalyst particle for polyester production according to any of Aspects 1 to 6, comprising a reaction product of a titanium compound component (A) including at least one titanium compound of the formula (I) (wherein k represents 1) and a phosphorus compound component (B) including at least one phosphorus compound (3) of the formula (111).

### <<Aspect 8>>

The catalyst particle for polyester production according to Aspect 7, wherein the reaction product of a titanium compound component (A) including at least one titanium compound of the formula (I) (wherein k represents 1) and a phosphorus compound component (B) including at least one phosphorus compound (3) of the formula (III) comprises a compound represented by the following formula (IV):

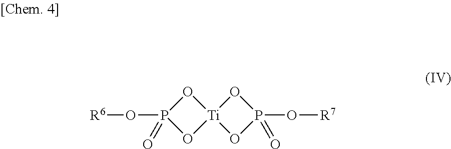

wherein R⁶ and R⁷ each mutually independently represent an alkyl group having 2 to 10 carbon atoms or an aryl group having 6 to 12 carbon atoms.

### <<Aspect 9>>

The catalyst particle for polyester production according to any of Aspects 1 to 8, wherein the reaction product of the titanium compound component (A) and the phosphorus compound component (B) is generated at a reaction starting temperature of 25 to 35° C. and at a reaction temperature of 50 to 200° C.

### <Aspect 10>>

A method for producing a polyester, comprising subjecting a polymerization starting material including at least one selected from an ester of an aromatic dicarboxylic acid and an alkylene glycol, and its low polymer, to polycondensation reaction in the presence of the catalyst particle for polyester production according to any of Aspects 1 to 9.

### <<Aspect 11>>

The method for producing a polyester according to Aspect 10, wherein a millimolar amount of a titanium atom contained in the catalyst particle is 2 to 40% based on a total millimolar amount of the aromatic dicarboxylic acid component contained in the polymerization starting material.

### <<Aspect 12>>

The method for producing a polyester according to Aspect 10 or 11, wherein the aromatic dicarboxylic acid is selected from terephthalic acid, isophthalic acid, naphthalenedicarboxylic acid, diphenyldicarboxylic acid, diphenylsulfonedicarboxylic acid, diphenylmethanedicarboxylic acid, diphenyl ether dicarboxylic acid, diphenoxyethanedicarboxylic acid, and β-hydroxyethoxybenzoic acid.

### <<Aspect 13>>

The method for producing a polyester according to Aspect 12, wherein the terephthalic acid is obtained by depolymerization of polyalkylene terephthalate and hydrolysis of dimethyl terephthalate thus obtained.

### <<Aspect 14>>

The method for producing a polyester according to Aspect 10 or 11, wherein the ester of the aromatic dicarboxylic acid and the alkylene glycol is an ester of terephthalic acid and an alkylene glycol, and is obtained by depolymerization of polyalkylene terephthalate and transesterification reaction of dimethyl terephthalate thus obtained and an alkylene glycol.

### <<Aspect 15>>

The method for producing a polyester according to Aspect 13 or 14, wherein the polyalkylene terephthalate to be subjected to depolymerization is a polyalkylene terephthalate molded product disposed of and/or a polymer scrap recovered in a production process of polyalkylene terephthalate.

### <<Aspect 16>>

The method for producing a polyester according to any of Aspects 10 to 15, wherein the alkylene glycol is selected from ethylene glycol, trimethylene glycol, tetramethylene glycol, neopentyl glycol, and hexamethylene glycol.

### <<Aspect 17>>

The method for producing a polyester according to any of Aspects 10 to 16, wherein the polycondensation reaction is performed at a temperature of 230 to 320° C.

### <<Aspect 18»

A polyester produced by the method according to any of Aspects 10 to 17.

### <<Aspect 19>>

The polyester according to Aspect 18, having an intrinsic viscosity of 0.30 to 0.90, wherein a content of a cyclic trimer in the ester of the aromatic dicarboxylic acid and the alkylene glycol is 0.50% by mass or less, and a content of acetaldehyde is 5 ppm or less.

### <<Aspect 20>>

The polyester according to Aspect 18 or 19, wherein an antioxidant comprising at least one hindered phenol compound is contained at a content of 1% by mass or less based on a mass of the polyester.

### <<Aspect 21>>

A molded article comprising the polyester according to any of Aspects 18 to 20.

### <<Aspect 22>>

The molded article according to Aspect 21, selected from a bottle-shaped product, a sheet-shaped product, a thermally molded container, and an injection molded article.

### <<Aspect 23>>

A polyester fiber obtained by melting a resin raw material comprising the polyester according to any of Aspects 18 to 20, and extruding this molten body into a fiber and solidifying the fiber.

### <Aspect 24>>

A polyester film obtained by melting a resin raw material comprising the polyester according to any of Aspects 18 to 20, extruding this molten body into a sheet and solidifying the sheet, and stretching an unstretched film obtained, in a biaxial direction.

### Advantageous Effects of Invention

A polyester obtained with the catalyst particle of the present invention has a favorable color tone and is favorable in transparency (low in haze) after molding, and thus can be suitably used for various molded articles, and the industrial effect exerted is superior.

### DESCRIPTION OF EMBODIMENTS

The catalyst particle for polyester production of the present invention comprises a reaction product of a titanium compound component (A) and a phosphorus compound component (B), described below in detail, and the particle size D₅₀ and the particle size D₉₀ thereof are respectively 10.0 μm or less and 20.0 μm or less.

The particle size D₅₀ is preferably 7.0 μm or less, more preferably 5.0 μm or less, further preferably 4.8 μm or less, particularly preferably 4.7 μm or less. The particle size D₉₀ is preferably 18.0 μm or less, more preferably 16.0 μm or less, further preferably 15.0 μm or less, particularly preferably 14.5 μm or less. When the particle sizes of the catalyst particle for polyester production are in the above ranges, a polyester obtained with the catalyst particle has the advantage of not only being favorable in color tone, but also being favorable in transparency (low in haze) after molding of the polyester. Furthermore, the particle size D₁₀ of the catalyst particle is preferably 5.0 μm or less, more preferably 4.0 μm or less, further preferably 3.0 μm or less, particularly preferably 2.0 μm or less, and is set in the above range to thereby provide the same effects as described above.

The particle size distribution represented by D₉₀/D₁₀ is preferably 15.0 or less, more preferably 10.0 or less, further preferably 8.0 or less, particularly preferably 5.0 or less. The particle size distribution is set in the above range to thereby provide the same effects as described above.

The particle size of the catalyst particle is determined from a particle size distribution obtained by subjecting the catalyst particle dissolved in ethylene glycol, to a laser diffraction type particle size distribution measurement apparatus. D₁₀, D₅₀, and D₉₀ are respectively particle sizes where integrated values in the particle size distribution are 10%, 50%, and 90%. D₅₀ represents the average value (median size) of the particle, and a smaller D₅₀ means a smaller average particle size. The particle size distribution is evaluated based on D₉₀/D₁₀, and a smaller D₉₀/D₁₀ means that the particle size distribution is narrower.

The reaction molar ratio m_{Ti}:m_{P} of the molar amount in terms of titanium atom (m_{Ti}) of the titanium compound component (A) to the molar amount in terms of phosphorus atom (m_{P}) of the phosphorus compound component (B), in the reaction product of the titanium compound component (A) and the phosphorus compound component (B), is preferably in the range from 1:1 to 1:3, more preferably in the range from 1:1 to 1:2.

The molar amount in terms of titanium atom of the titanium compound component (A) is the total value of the product of the molar amount of each titanium compound contained in the titanium compound component (A) and the number of titanium atoms contained in one molecule of such each titanium compound, and the molar amount in terms of phosphorus atom of the phosphorus compound component (B) is the total value of the product of the molar amount of each phosphorus compound contained in the phosphorus compound component (B) and the number of phosphorus atoms contained in one molecule of such each phosphorus compound. Herein, the phosphorus compound of the formula (III) contains one phosphorus atom per molecule, and thus the molar amount in terms of phosphorus atom of the phosphorus compound is equal to the molar amount of the phosphorus compound.

If the reaction molar ratio m_{Ti}: m_{P} is more than 1:1, namely, the amount of the titanium compound component (A) is too small, a polyester obtained with a catalyst obtained may be inferior in color tone (too high in b value) and may be deteriorated in heat resistance. If the reaction molar ratio m_{Ti}: m_{P} is less than 1:3, namely, the amount of the titanium compound component (A) is too large, a catalyst obtained may be insufficient in catalyst activity of polyester generation reaction.

### <Titanium Compound Component (A)>

The titanium compound component (A) for use in the catalyst particle of the present invention consists of at least one selected from
a titanium compound (1) represented by the following general formula (I): and
a titanium compound (2) obtained by reaction of a titanium compound (1) of the following general formula (I) and an aromatic polyvalent carboxylic acid represented by the following general formula (II), or its anhydride.

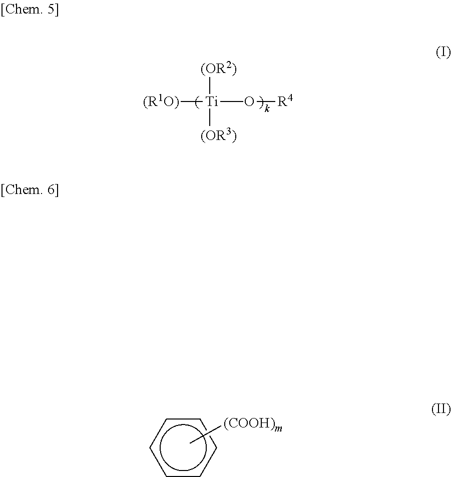

In the formula (I), R¹, R², R³and R⁴ respectively represent alkyl groups which are the same as or different from one another and which have 2 to 10, preferably 2 to 6 carbon atoms, k represents an integer of 1 to 3, preferably 1, and when k represents 2 or 3, two or three R²and R³ may be each the same as or different from each other.

In the formula (II), m represents 2 to 4, preferably an integer of 2 or 3.

Examples of the titanium compound (1) of the general formula (I) can include titanium tetra-alkoxide compounds such as titanium tetra-butoxide, titanium tetra-isopropoxide, titanium tetra-propoxide, and titanium tetra-ethoxide, and alkyl titanate compounds such as octaalkyl trititanate compounds and hexaalkyl dititanate compounds, and in particular, a titanium tetra-alkoxide compound favorable in reactivity with the phosphorus compound component for use in the present invention is preferably used, and particularly titanium tetra-butoxide is more preferably used.

The aromatic polyvalent carboxylic acid of the general formula (II), and its anhydride are preferably selected from phthalic acid, trimellitic acid, hemimellitic acid, pyromellitic acid, and their anhydrides. In particular, trimellitic acid anhydride is more preferably used which is good in reactivity with the titanium compound (1) and in which a polycondensation catalyst obtained is high in affinity with a polyester.

The reaction of the titanium compound (1) and the aromatic polyvalent carboxylic acid of the general formula (II) or its anhydride is performed by mixing the aromatic polyvalent carboxylic acid or its anhydride with a catalyst and dissolving one portion of or all the mixture in a solvent, dropping the titanium compound (1) into this mixed liquid, and heating the resultant at a temperature of 0° C. to 200° C. for 30 minutes or more, preferably at a temperature of 30 to 150° C. for 40 to 90 minutes. The reaction pressure here is not particularly limited, and may be ordinary pressure. Herein, the solvent can be appropriately selected from those capable of dissolving one portion of or all the predetermined amount of the compound of the formula (II), or its anhydride, and is preferably selected from ethanol, ethylene glycol, trimethylene glycol, tetramethylene glycol, benzene and xylene.

The reaction molar ratio of the titanium compound (1) and the compound of the formula (II), or its anhydride is not limited. However, a too high proportion of the titanium compound (1) may cause deterioration in color tone of a polyester obtained and/or a decrease in softening point, and on the contrary, a too low proportion of the titanium compound (I) may hardly allow for the progress of polycondensation reaction. Thus, the reaction molar ratio of the titanium compound (1) and the compound of the formula (II), or its anhydride is preferably controlled to be in the range from 2:1 to 2:5. A reaction product obtained by the reaction may be subjected to the following reaction with the phosphorus compound (3), as it is, or may also be recrystallized and purified with a solvent including acetone, methyl alcohol ethyl acetate, and/or the like and then allowed to react with the phosphorus compound (3).

### <Titanium Compound Component (B)>

The phosphorus compound component (B) for use in the catalyst particle of the present invention consists of at least one phosphorus compound (3) represented by the following general formula (III).

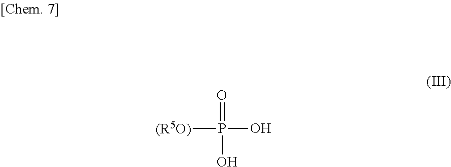

In the formula (III), R⁵ represents an unsubstituted or substituted, aryl group having 6 to 20, preferably 6 to 12 carbon atoms or alkyl group having 1 to 20, preferably 1 to 12 carbon atoms.

The C6-C20 aryl group or C1-C20 alkyl group represented by R⁵, in the phosphorus compound (3) of the general formula (III), for use in the phosphorus compound component (B), may be unsubstituted, or may be substituted with one or more substituents. Such substituents encompass, for example, a carboxyl group, an alkyl group, a hydroxyl group, an amino group, and the like.

The phosphorus compound (3) of the general formula (III) encompasses, for example, monoalkyl phosphate compounds and monoaryl phosphate compounds, such as monomethyl phosphate, monoethyl phosphate, monotrimethyl phosphate, mono-n-butyl phosphate, monohexyl phosphate, monoheptyl phosphate, monooctyl phosphate, monononyl phosphate, monodecyl phosphate, monododecyl phosphate, monolauryl phosphate, monooleyl phosphate, monotetradecyl phosphate, monophenyl phosphate, monobenzyl phosphate, mono(4-dodecyl)phenyl phosphate, mono(4-methylphenyl)phosphate, mono(4-ethylphenyl)phosphate, mono(4-propylphenyl)phosphate, mono(4-dodecylphenyl)phosphate, monotolyl phosphate, monoxylyl phosphate, monobiphenyl phosphate, mononaphthyl phosphate, and monoanthryl phosphate, and these may be used singly or as a mixture of two or more kinds thereof, for example, as a mixture of monoalkyl phosphate and monoaryl phosphate. Herein, when the phosphorus compound is used in the form of a mixture of two or more kinds thereof, the proportion of the monoalkyl phosphate is preferably 50% or more, more preferably 90% or more, further preferably 100%.

### <Preparation of Catalyst Particle>

Preparation of the catalyst particle of the present invention from the titanium compound component (A) and the phosphorus compound component (B) is performed by, for example, adjusting the reaction starting temperature in an alkylene glycol solution containing the titanium compound component (A), to 25 to 35° C., preferably 27 to 33° C., dropping, into this mixed liquid, a mixture liquid of the component (B) including at least one phosphorus compound (3) of the formula (III), with a solvent, and heating the reaction system at a temperature of 50° C. to 200° C., preferably 70 to 150° C., for 1 minute to 4 hours, preferably 30 minutes to 2 hours.

The reaction is not especially limited with respect to the reaction pressure, may be performed under any of pressure (0.1 to 0.5 MPa), ordinary pressure, or reduced pressure (0.001 to 0.1 MPa), and is usually performed under ordinary pressure.

The solvent for the phosphorus compound component (B) of the formula (Ill), for use in the catalyst particle preparation reaction, is not especially limited as long as it can dissolve at least one portion of the phosphorus compound component (B), and for example, a solvent including at least one selected from ethanol, ethylene glycol, trimethylene glycol, tetramethylene glycol, benzene, and xylene is preferably used. In particular, the solvent here used is preferably the same compound as the glycol component constituting a polyester to be finally obtained.

The compounding ratio of the titanium compound component (A) and the phosphorus compound component (B) in the reaction system in the catalyst particle preparation reaction, in terms of the reaction molar ratio m_{Ti}:m_{P} of the molar amount in terms of titanium atom m_{Ti}) of the titanium compound component (A) to the molar amount in terms of phosphorus atom (m_{P}) of the phosphorus compound component (B) in the reaction product of the titanium compound component (A) and the phosphorus compound component contained in the catalyst particle obtained, is set to be in the range from 1:1 to 1:3, preferably 1:1 to 1:2.

The reaction product of the titanium compound component (A) and the phosphorus compound component (B) may be used as a catalyst for polyester production, without purification after separation of the reaction product from the reaction system by a procedure such as centrifugal settling treatment or filtration, or may be used as the catalyst, in the form of a purified product obtained by recrystallizing the reaction product separated, with a recrystallization agent such as acetone, methyl alcohol and/or water, and purifying the reaction product. The reaction product, which is not separated from the reaction system, may also be used as a catalyst-containing mixture as it is, in the form of a reaction product-containing reaction mixture.

In one aspect of the catalyst particle for polyester production of the present invention, a reaction product of at least one titanium compound (1) of the formula (I) (wherein k represents 1), namely, a titanium compound component (A) including titanium tetra-alkoxide, and a phosphorus compound component (B) including at least one phosphorus compound of the formula (III) is used as a catalyst.

In the catalyst particle, the reaction product of the titanium compound component including at least one titanium compound (1) of the formula (1) (wherein k=1) and the phosphorus compound component including at least one phosphorus compound of the formula (III) contains a compound represented by the following (IV). Herein, R⁶ and R⁷ groups in the formula (IV) each mutually independently represent an alkyl group having 2 to 10 carbon atoms, derived from any one or more of R¹, R², R³and R⁴of the titanium compound (1), or an alkyl group having 6 to 12 carbon atoms, derived from an R⁵ group of the phosphorus compound (3).

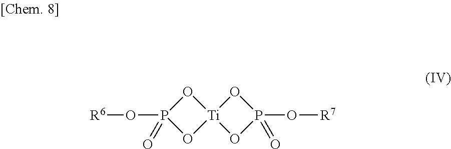

A catalyst particle comprising the titanium/phosphorus compound represented by the formula (IV) has high catalyst activity, and a polyester produced with this catalyst particle has a favorable color tone and is favorable in transparency (low in haze) after molding, and has practically sufficient polymer performance.

The catalyst particle for polyester production of the present invention preferably comprises 50% by mass or more, more preferably 70% by mass or more of the titanium/phosphorus compound of the general formula (IV).

### <Method for Producing Polyester>

A polymerization starting material including at least one selected from an alkylene glycol ester of an aromatic dicarboxylic acid, and its low polymer (oligomer), is polycondensed in the presence of the catalyst particle in the polyester production method of the present invention. The millimolar amount in terms of titanium atom of the catalyst particle here used, is preferably set to 2 to 40%, further preferably 3 to 35%, still further preferably 4 to 30% based on the total millimolar amount of the aromatic dicarboxylic acid component contained in the polymerization starting material. If the millimolar amount in terms of titanium atom of the catalyst particle is less than 2%, the catalyzing effect for the polycondensation reaction of the polymerization starting material may be insufficient and the polyester production efficiency may be insufficient, and a polyester having a desired degree of polymerization cannot be sometimes obtained. If the millimolar amount in terms of titanium atom of the catalyst particle is more than 40%, a polyester obtained may be insufficient in color tone (b value) to thereby have yellowness, and may be deteriorated in practicality.

The aromatic dicarboxylic acid in the alkylene glycol ester of the aromatic dicarboxylic acid for use as the polymerization starting material in the polyester production method of the present invention is preferably selected from terephthalic acid, isophthalic acid, naphthalenedicarboxylic acid, diphenyldicarboxylic acid, diphenylsulfonedicarboxylic acid, diphenylmethanedicarboxylic acid, diphenyl ether dicarboxylic acid, diphenoxyethanedicarboxylic acid, and β-hydroxyethoxybenzoic acid, and in particular, terephthalic acid and naphthalenedicarboxylic acid are more preferably used.

The alkylene glycol is preferably selected from ethylene glycol, trimethylene glycol, tetramethylene glycol, neopentyl glycol, and hexamethylene glycol.

The method for producing the alkylene glycol ester of the aromatic dicarboxylic acid, and/or its low polymer is not restricted, and the alkylene glycol ester is usually produced by heating reaction of the aromatic dicarboxylic acid or its ester-forming derivative, and the alkylene glycol or its ester-forming derivative.

For example, an ethylene glycol ester of terephthalic acid, and/or its low polymer, for use as a raw material of polyethylene terephthalate, is produced by a method involving direct esterification reaction of terephthalic acid and ethylene glycol, transesterification reaction of a lower alkyl ester of terephthalic acid, and ethylene glycol, or addition reaction of ethylene oxide to terephthalic acid.

A trimethylene glycol ester of terephthalic acid, and/or its low polymer, as a raw material of polytrimethylene terephthalate is produced by a method involving direct esterification reaction of terephthalic acid and trimethylene glycol, transesterification reaction of a lower alkyl ester of terephthalic acid, and trimethylene glycol, or addition reaction of trimethylene oxide to terephthalic acid.

The alkylene glycol ester of the aromatic dicarboxylic acid, and/or its low polymer may comprise other dicarboxylic acid ester copolymerizable therewith, as an additional component, in an amount falling within a range where the effects of the method of the present invention are not substantially impaired, specifically, in an amount of addition, falling within the range of 10% by mol or less, preferably 5% by mol or less, based on the molar amount of the total acid component.

The above copolymerizable additional component is preferably selected from esters of one or more acid components, for example, aliphatic and alicyclic dicarboxylic acids such as adipic acid, sebacic acid, and 1,4-cyclohexanedicarboxylic acid, and hydroxycarboxylic acids such as β-hydroxyethoxybenzoic acid and p-oxybenzoic acid, and one or more glycol components, for example, aliphatic, alicyclic, and aromatic diol compounds such as alkylene glycols having 2 or more constituent carbon atoms, 1,4-cyclohexanedimethanol, neopentyl glycol, bisphenol A, and bisphenol S, and polyoxyalkylene glycol, or their anhydrides. These additional component esters may be used singly or in combination of two or more kinds thereof. Herein, the amount of copolymerization is preferably in the above range.

When terephthalic acid and/or dimethyl terephthalate are/is used as starting raw material(s), dimethyl terephthalate recovered, obtained by depolymerization of polyalkylene terephthalate, or terephthalic acid recovered, obtained by hydrolysis of the dimethyl terephthalate, can also be used at a rate of 70% by mass or more based on the mass of the total acid component constituting a polyester. In this case, the objective polyalkylene terephthalate is preferably polyethylene terephthalate, and it is preferable, from the viewpoint of effective utilization of a resource, to use, in particular, a PET bottle recovered, a fiber product recovered, a polyester film product recovered, furthermore a polymer scrap generated in a production process of such a product, and/or the like, for a raw material source for polyester production.

The method for obtaining dimethyl terephthalate by depolymerization of polyalkylene terephthalate recovered is not particularly limited, and any conventionally known method can be adopted. For example, a polyester can be obtained by depolymerizing polyalkylene terephthalate recovered, by use of ethylene glycol, then subjecting the depolymerized product to transesterification reaction by a lower alcohol, for example, methanol, purifying the reaction mixture to recover a lower alkyl ester of terephthalic acid, subjecting the lower alkyl ester to transesterification reaction by alkylene glycol, and polycondensing a phthalic acid/alkylene glycol ester obtained. The method for recovering terephthalic acid from the dimethyl terephthalate recovered is also not particularly restricted, and any conventional method may be used. For example, terephthalic acid can be recovered by recovering dimethyl terephthalate from a reaction mixture obtained by transesterification reaction, by a recrystallization method and/or a distillation method, and then heating and hydrolyzing the recovered product with water under high temperature and high pressure. The total content of 4-carboxybenzaldehyde, para-toluic acid, benzoic acid and hydroxydimethyl terephthalate in impurities in terephthalic acid obtained by the method is preferably 1 ppm or less. The content of monomethyl terephthalate is preferably in the range from 1 to 5000 ppm. A polyester can be produced by direct esterification reaction of the terephthalic acid recovered by the above method, and alkylene glycol, and polycondensation of an ester obtained.

The timing for addition of the catalyst particle to the polymerization starting material in the polyester production method of the present invention may be any stage before the timing of the start of polycondensation reaction of the alkylene glycol ester of the aromatic dicarboxylic acid, and/or its low polymer, and the method for addition thereof is also not restricted. For example, the alkylene glycol ester of the aromatic dicarboxylic acid may be prepared and a solution or slurry of the catalyst may be added into the reaction system to start the polycondensation reaction, or a solution or slurry of the catalyst may be added into the reaction system, together with the starting raw material or after charging of the starting raw material, in preparation of the aromatic dicarboxylic acid alkylene glycol ester.

The reaction conditions of polyester production in the method of the present invention are also not especially restricted. In general, the polycondensation reaction is preferably made by polycondensation at a temperature of 230 to 320° C. under ordinary pressure or under reduced pressure (0.1 to 0.1 MPa), or under a combination condition thereof, for 15 to 300 minutes.

A reaction stabilizer, for example, trimethyl phosphate may be, if necessary, added into the reaction system at any stage in polyester production in the method of the present invention, and furthermore, one or more of an antioxidant, an ultraviolet absorbent, a flame retardant, a fluorescent whitener, a delustering agent, a hue regulator, a defoamer, and other additive may be, if necessary, added into the reaction system. In particular, the polyester preferably comprises an antioxidant comprising at least one hindered phenol compound, and the content of the antioxidant based on the mass of the polyester is preferably 1% by mass or less. If the content is more than l% by mass, the antioxidant by itself may be thermally degraded to cause any failure such as deterioration in quality of a product obtained.

The hindered phenol compound for an antioxidant, for use in the polyester of the present invention, can be selected from pentaerythritol-tetrakis[3-(3,5-di-tert-butyl-4-hydroxyphenyl)propionate]. 3,9-bis{2-[3-(3-tert-butyl-4-hydroxy-5-methylphenyl)propionyloxy]-1,1-dimethylethyl}-2,4,8,10- tetraoxaspiro[5,5]undecane, 3-tris(2-methyl-4-hydroxy-5-tert-butylphenyl)butane, 1,3,5-trimethyl-2,4,6-tris(3,5-di-tert-butyl-4-hydroxybenzyl)benzene, 1,3,5-tris(4-tert-butyl-3 -hydroxy-2,6-dimethylbenzene)isophthalic acid, triethyl glycol -bis[3-(3-tert-butyl-5-methyl-4-hydroxyphenyl)propionate], 1,6-hexanediol-bis[3-(3,5-di-tert-butyl-4-hydroxyphenyl)propionate], 2,2-thio-diethylene-bis[3-(3,5-di-tert-butyl-4-hydroxyphenyl)propionate], octadecyl-[3-(3,5-di-tert-butyl-4-hydroxyphenyl)propionate], and the like. Such a hindered phenol-based antioxidant and a thioether-based secondary antioxidant can be preferably used in combination.

The method for adding the hindered phenol-based antioxidant to the polyester is not particularly restricted, and the hindered phenol-based antioxidant is preferably added at any stage after completion of transesterification reaction or esterification reaction, or until completion of polymerization reaction.

In order to finely adjust the color tone of a polyester obtained, a hue regulator including one or more of organic blue pigments and inorganic blue pigments such as azo-based, triphenylmethane-based, quinoline-based, anthraquinone-based, and phthalocyanine-based pigments can be added into the reaction system at a polyester production stage. Of course, it is not necessary in the production of the present invention to use an inorganic blue pigment containing cobalt or the like causing deterioration in melt heat stability of a polyester, as the hue regulator. Accordingly, a polyester obtained by the method of the present invention contains substantially no cobalt.

The intrinsic viscosity of the polyester of the present invention is not restricted, and is preferably in the range from 0.3 to 0.9. When the intrinsic viscosity is in the range, melt-molding is easily made and a molded product obtained therefrom is also high in strength. The intrinsic viscosity is further preferably in the range from 0.4 to 0.8, particularly preferably 0.5 to 0.7.

The intrinsic viscosity of the polyester is determined by dissolving an objective polyester in ortho-chlorophenol and performing measurement at a temperature of 35° C. A polyester obtained by solid-phase polycondensation is commonly often utilized for a bottle or the like, and thus is contained in a polyester and has an intrinsic viscosity of 0.70 to 0.90. The content of a cyclic trimer and the content of acetaldehyde, in the ester of the aromatic dicarboxylic acid and the alkylene glycol, are preferably 0.5% by weight or less and 5 ppm or less, respectively. The cyclic trimer encompasses alkylene terephthalates such as ethylene terephthalate, trimethylene terephthalate, tetramethylene terephthalate, and hexamethylene terephthalate, and alkylene naphthalates such as ethylene naphthalate, trimethylene naphthalate, tetratnethylene naphthalate and hexamethylene naphthalate.

The L value, as the color tone (L value and b value) of a polyester obtained with the catalyst particle of the present invention, is preferably 70 or more, more preferably 75 or more, further preferably 77 or more, particularly preferably 78 or more. The b value is preferably in the range from −5.0 to 5.0, more preferably in the range from −4.0 to 4.0, further preferably in the range from −3.0 to 3.0, particularly preferably in the range from −2.0 to 2.0. The above ranges are preferred because the polyester is excellent in color tone.

The Haze value at a thickness of 3 mm of a molded plate after molding of a polyester obtained with the catalyst particle of the present invention is preferably 5.0 or less, more preferably 4.5 or less, further preferably 4.0 or less, particularly preferably 3.8 or less. The above range is preferred because the polyester is excellent in transparency.

### EXAMPLES

The present invention is more specifically further described with reference to Examples, but the scope of the present invention is not limited by these Examples. Herein, the following measurements were performed in Examples.

(1) Particle Size of Catalyst Particle

The particle size of a catalyst particle for use in polyester production was measured by subjecting the catalyst particle dissolved in ethylene glycol, to a laser diffraction type particle size distribution measurement apparatus (“SALD-2000” manufactured by Shimadzu Corporation).

(2) Limiting Viscosity (IV)

The limiting viscosity (IV) of a polyester polymer was calculated from the value of the solution viscosity determined by dissolving 0.6 g of a polyester specimen in 50 mL of o-chlorophenol and then subjecting the solution to measurement with an Uberode viscometer at 35° C.

(3) Diethylene Glycol (DEG) Content The DEG content was measured by decomposing a polyester pellet by hydrazine hydrate and subjecting this decomposed product to gas chromatography (“GC-2014” manufactured by Shimadzu Corporation)).

(4) Number of Carboxyl Groups at Terminal

The number of carboxyl groups at a terminal of a polyester polymer was determined by converting a titration value obtained by dissolution of the polyester polymer in benzyl alcohol and neutralization titration with sodium hydroxide, into a numerical value per unit weight.

(5) Color Tone (L Value and b Value)

A polyester polymer was treated in a nitrogen atmosphere at 140° C. for 1 hour, thereafter 65 g thereof was packed in a cylindrical container having a diameter of 5 cm and a height of 5 cm, and the L value and the b value were measured with a colorimetric color-difference meter “ZE6000” manufactured by Nippon Denshoku Industries Co., Ltd. The L value represents lightness and a larger number indicates a higher lightness of a sample, and a larger b value indicates a higher degree of yellow coloration of a sample.

(6) Analysis of Titanium and Phosphorus Concentrations

The concentrations of titanium and phosphorus atoms in a catalyst were measured by setting a dried catalyst sample on a scanning, electron microscope (SEM, S-3500N manufactured by Hitachi High-Tech Corporation) and using an energy dispersive X-ray microanalyzer (XMA, EMAX-7000 manufactured by Horiba Ltd.) connected to the microscope.

The concentration of a catalyst metal in a polyester polymer was determined with a heating a particulate sample on an aluminum plate to 90° C., and then forming the sample into a test sample by a compression pressor.

(7) Measurement of Haze of Molded Plate

A polyester polymer was dried with a shelf drier at a temperature 110° C. and at ordinary pressure under a nitrogen flow condition for 5 hours or more, and thereafter subjected to an injection molding machine (“NPX7-1F” manufactured by NISSEI PLASTIC INDUSTRIAL CO., LTD.) and injection molded into a molded plate having a length of 30 mm, a width of 30 mm, and a thickness of 3 mm under conditions of a cylinder temperature of 280° C., a screw rotation speed of 105 rpm, a die cooling temperature of 15° C., and a cycle time of 30 seconds. The haze of the molded plate obtained was measured with a turbidimeter “NDH2000” manufactured by Nippon Denshoku Industries Co., Ltd. A lower haze indicates a higher transparency.

### Example 1

### <Preparation of Catalyst Particle>

A three-necked flask having a volume of 300 mL, in which the content could be heated and stirred, was loaded with 85.3 g of ethylene glycol, and the content was heated to 100° C. with stirring. Next, 14.7 g of monobutyl phosphate was added, and the mixture was stirred to thereby obtain a transparent solution. Hereinafter, this solution is designated as “P solution”.

A three-necked flask having a volume of 300 mL, in which the content could be heated and stirred, was loaded with 285.04 g of ethylene glycol and 0.29 g of acetic acid, and the content was stirred at 30° C. Next, the mixed liquid was heated to 50° C., thereafter 2.05 g of titanium tetra-butoxide was slowly added, and thus an ethylene glycol solution of a titanium compound was prepared. Hereinafter, this solution is designated as “T1 solution”.

The T1 solution was cooled to 30° C. and then kept at 30° C., and 12.62 g of the P solution was slowly added thereinto. Subsequently, the reaction liquid was heated to 120° C. and then stirred for 2 hours, to thereby allow such phosphorus compound and titanium compound to react. After completion of the reaction, the temperature was dropped to room temperature and the particle size was measured. The average particle sizes were as follows: D₁₀=1.8 μm, D₅₀=3.9 μm, 1)90 =7.9 μm. Hereinafter, this catalyst-containing slurry is designated as “TP1 catalyst slurry”.

The respective concentrations of titanium and phosphorus atoms in the catalyst particle in the TP-1 catalyst slurry were determined as follows. The TP-1 catalyst slurry was filtered with a filter having an aperture of 5 μm, and then washed with water and dried to thereby obtain a solid. The solid obtained was analyzed with an XMA apparatus linked to SEM, and as a result, the titanium concentration was 11%, the P concentration was 15%, and the molar ratio of the phosphorus atom to the titanium atom was 2.

### <Formation of Polyester by Polymerization>

Under conditions of nitrogen atmosphere, 246° C., and ordinary pressure, a slurry prepared by mixing 17.3 kg of high-purity terephthalic acid and 9.2 kg of ethylene glycol was supplied at a constant rate to a reactor where 26.4 kg of an ethylene glycol-terephthalic acid oligomer was retained, and stirred for 3 hours for esterification.

A polycondensation reaction tank was loaded with 26.4 kg of an ester oligomer obtained by the esterification reaction, and 206 g of the TPI catalyst slurry as a polycondensation catalyst and 0.016 g of a blue hue regulator (CI Solvent Blue 45) were added. While this reaction solution was stirred, the reaction temperature was raised stepwise from 255 to 280° C. and at the same time the reaction pressure was reduced stepwise from ordinary pressure to 60 Pa, and, while water and ethylene glycol generated by polycondensation reaction of the ester oligomer were removed outside the system, the polycondensation reaction of the ester oligomer was performed. Progress of the polycondensation reaction was checked by the change in load on a stirring blade, and the reaction was terminated when the degree of polymerization of a polyester produced reached a desired degree. The polycondensation reaction time here was 151 minutes. Thereafter, the reaction mixture in the system was continuously extruded into a strand shape through an ejection port, and such a strand was cooled and solidified, and cut, to thereby obtain a particulate pellet having a particle size of about 3 mm. Hereinafter, the polyethylene terephthalate is designated as “PET 1”.

The PET 1 obtained had an IV value of 0.545 and a diethylene glycol (DEG) content of 1.2% by weight. The L value and the h value, in terms of the color phase of the pellet, were respectively 78 and −1.1. The concentration of a catalyst metal contained, the titanium concentration, was 10 ppm (4% by mmol), and the phosphorus concentration was 15 ppm (9% by mmol).

### <Molding Evaluation>

The PET 1 obtained was used to form a molded plate having a thickness of 3 mm by the following method. The PET 1 (1 kg) was dried with a shelf drier at a temperature 110° C. and at ordinary pressure under a nitrogen flow condition for 5 hours or more. Next, the PET 1 dried was subjected to an injection molding machine (“NPX7-1F” manufactured by NISSEI PLASTIC INDUSTRIAL CO., LTD.) and injection molded into a molded plate having a length of 30 mm, a width of 30 mm, and a thickness of 3 mm under conditions of a cylinder temperature of 280° C., a screw rotation speed of 105 rpm, a die cooling temperature of 15° C., and a cycle time of 30 seconds. The haze of the molded plate obtained was measured. The haze was 3.74%. The measurement results are shown in Table 1.

### Example 2

### <Preparation of Catalyst Particle>

A P solution was prepared in the same manner as in Example 1.

A three-necked flask having a volume of 300 mL, in which the content could be heated and stirred, was charged with 285.04 g of ethylene glycol and 0.29 g of acetic acid, and the content was stirred at 30° C. Thereto was slowly added 2.05 g of titanium tetra-butoxide, and an ethylene glycol solution of a titanium compound was prepared. Hereinafter, this solution is designated as “T2 solution”.

The T2 solution was kept at 30° C., and 12.62 g of the P solution was slowly added thereinto. Subsequently, the reaction liquid was heated to 120° C. and then stirred for 2 hours, to allow such phosphorus compound and titanium compound to react. After completion of the reaction, the temperature was dropped to room temperature and the particle size was measured. The average particle sizes were as follows: D₁₀=1.9 μm, D₅₀=4.6 μm, D90=14.4 μm. Hereinafter, the catalyst-containing slurry is designated as “TP2 catalyst slurry”.

The respective concentrations of titanium and phosphorus atoms in the catalyst particle in the TP-2 catalyst slurry were determined in the same manner as in Example 1, and the titanium concentration was 9%, the P concentration was 13%, and the molar ratio of the phosphorus atom to the titanium atom was 2.

### <Formation of Polyester by Polymerization>

The same polymerization as in Example 1 was performed except that the TP2 catalyst slurry was used instead of the TP1 catalyst slurry. The polymerization reaction time was 152 minutes. Hereinafter, polyethylene terephthalate obtained is designated as “PET 2”. The PET 2 had an IV value of 0.547 and a diethylene glycol (DEC) content of 1.0% by weight. The L value and the b value, in terms of the color phase of the pellet, were respectively 80 and 1.4. The concentration of a catalyst metal contained, the titanium concentration, was 9 ppm (4% by mmol), and the phosphorus concentration was 15 ppm (9% by mmol).

### <Evaluation of Molding>

A molded plate having a thickness of 3 mm was formed and the haze thereof was measured in the same manner as in Example 1 except that the PET 2 was used instead of the PET 1. The haze was 3.71%. The measurement results are shown in Table 1.

### Comparative Example 1

### <Preparation of Catalyst Particle>

A P solution was prepared in the same manner as in Example 1.

A three-necked flask having a volume of 300 mL, in which the content could be heated and stirred, was charged with 285.04 g of ethylene glycol and 0.29 g of acetic acid, and the content was stirred at 50° C. Thereto was slowly added 2.05 g of titanium tetra-butoxide, and an ethylene glycol solution of a titanium compound was prepared. Hereinafter, this solution is designated as “T3 solution”.

The T3 solution was kept at 50° C., and 12.62 g of the P solution was slowly added thereinto. Subsequently, the reaction liquid was heated to 120° C. and then stirred for 2 hours, to allow such phosphorus compound and titanium compound to react. After completion of the reaction, the temperature was dropped to room temperature and the particle size was measured. The average particle sizes were as follows: D₁₀=1.3 μm, D₅₀=4.9 μm, D₉₀=20.4 μm. Hereinafter, the catalyst-containing slurry is designated as “TP3 catalyst slurry”.

The respective concentrations of titanium and phosphorus atoms in the catalyst particle in the TP-3 catalyst slurry were determined in the same manner as in Example 1, and the titanium concentration was 10%, the P concentration was 14%, and the molar ratio of the phosphorus atom to the titanium atom was 2.

### <Formation of Polyester by Polymerization>

The same polymerization as in Example 1 was performed except that the TP3 catalyst slurry was used instead of the TP1 catalyst slurry. The polymerization reaction time was 182 minutes. Hereinafter, the resulting polyethylene terephthalate is designated as “PET 3”. The PET 3 had an IV value of 0.545 and a diethylene glycol (DEG) content of 0.9% by weight. The L value and the b value, in terms of the color phase of the pellet, were respectively 79 and 2.2. The concentration of a catalyst metal contained, the titanium concentration, was 10 ppm (4% by mmol), and the phosphorus concentration was 15 ppm (9% by mmol).

### <Evaluation of Molding>

A molded plate having a thickness of 3 mm was formed and the haze thereof was measured in the same manner as in Example 1 except that the PET 3 was used instead of the PET 1. The haze was 5.09%. The measurement results are shown in Table 1.

### Comparative Example 2

### <Preparation of Catalyst Particle>

A P solution was prepared in the same manner as in Example 1.

A three-necked flask having a volume of 300 mL, in which the content could be heated and stirred, was charged with 285.04 g of ethylene glycol and 0.29 g of acetic acid, and the content was stirred at 120° C. Thereto was slowly added 2.05 g of titanium tetra-butoxide, and an ethylene glycol solution of a titanium compound was prepared. Hereinafter, this solution is designated as “T4 solution”.

The T4 solution was kept at 120° C., and 12.62 g of the P solution was slowly added thereinto. Subsequently, the reaction liquid was stirred for 2 hours, to allow such phosphorus compound and titanium compound to react. After completion of the reaction, the temperature was dropped to room temperature and the particle size was measured. The average particle sizes were as follows: D₁₀=2.7 μm, D₅₀=11.5 μm, D₉₀=31.2 μm. Hereinafter, the catalyst-containing slurry is designated as “TP4 catalyst slurry”.

The respective concentrations of titanium and phosphorus atoms in the catalyst particle in the TP-4 catalyst slurry were determined in the same manner as in Example 1, and the titanium concentration was 9%, the P concentration was 13%, and the molar ratio of the phosphorus atom to the titanium atom was 2.

### <Formation of Polyester by Polymerization>

The same polymerization as in Example 1 was performed except that the TP4 catalyst slurry was used instead of the TP1 catalyst slurry. The polymerization reaction time was 114 minutes. Hereinafter, the resulting polyethylene terephthalate is designated as “PET 4”. The PET 4 had an IV value of 0.557 and a diethylene glycol (DEG) content of 0.9% by weight. The L value and the b value, in terms of the color phase of the pellet, were respectively 79 and −1.1. The concentration of a catalyst metal contained, the titanium concentration, was 11 ppm (4% by mmol), and the phosphorus concentration was 15 ppm (9% by mmol).

### <Evaluation of Molding>

A molded plate having a thickness of 3 mm was formed and the haze thereof was measured in the same manner as in Example 1 except that the PET 4 was used instead of the PET 1. The haze was 4.36%. The measurement results are shown in Table 1.

TABLE 1

| | Synthesis conditions of TP catalyst | | | | | | | | | |
|---|---|---|---|---|---|---|---|---|---|---|
| | Temperature | | | | | | | | Molar ratio | |
| | in addition | Temperature | Reaction | | | | | | of atoms in | Polymer- |
| | of titanium | in addition | starting | Reaction | Particle size of TP catalyst | | | | TP catalyst | ization |
| | tetra-butoxide | of P solution | temperature | temperature | D₁₀ | D₅₀ | D₉₀ | D₉₀/D₁₀ | mₙ:mₚ | time |
| | ° C. | ° C. | ° C. | ° C. | μm | μm | μm | — | — | min |
| Example 1 | 50 | 30 | 30 | 120 | 1.8 | 3.9 | 7.9 | 4.3 | 1:2 | 151 |
| Example 2 | 30 | 30 | 30 | 120 | 1.9 | 4.6 | 14.4 | 7.6 | 1:2 | 152 |
| Comparative | 50 | 50 | 50 | 120 | 1.3 | 4.9 | 20.4 | 15.4 | 1:2 | 182 |
| Example 1 | | | | | | | | | | |
| Comparative | 120 | 120 | 120 | 120 | 2.7 | 11.5 | 31.2 | 11.6 | 1:2 | 114 |
| Example 2 | | | | | | | | | | |

| | Polymer quality | | | | | | | | | 3-mm |
|---|---|---|---|---|---|---|---|---|---|---|
| | | | | DEG | | Ti | | P | | molded |
| | IV | Color | | % by | COOH | | % by | | % by | plate |
| | dl/g | L | b | weight | eq/T | ppm | mmol | ppm | mmol | HAZE |
| Example 1 | 0.545 | 78.0 | −1.1 | 1.2 | 62 | 10 | 4 | 15 | 9 | 3.74 |
| Example 2 | 0.547 | 79.5 | 1.4 | 1.0 | 66 | 9 | 4 | 15 | 9 | 3.71 |
| Comparative | 0.545 | 79.4 | 2.2 | 0.9 | 72 | 10 | 4 | 15 | 9 | 5.09 |
| Example 1 | | | | | | | | | | |
| Comparative | 0.557 | 79.3 | −1.1 | 0.9 | 22 | 11 | 4 | 15 | 9 | 4.36 |
| Example 2 | | | | | | | | | | |

As clear from Table 1, it has been confirmed that polyesters obtained by using the titanium/phosphorus reaction compound catalysts described in Examples 1 to 2 according to the present invention are lower in haze after molding and more excellent in transparency than polyesters obtained by using the titanium/phosphorus reaction compound catalysts described in Comparative Examples 1 to 2.

### INDUSTRIAL APPLICABILITY

The catalyst particle for polyester production and the method for producing a polyester by use of the catalyst particle, of the present invention, can allow for provision of a polyester resin excellent in transparency after molding (low in haze), and have practically excellent usability.

1. A catalyst particle for polyester production, comprising a reaction product of the following titanium compound component (A) and phosphorus compound component (B), wherein
a particle size D₅₀ is 10.0 μm or less, and
a particle size D₅₀ is 20.0 μm or less:
(A) a titanium compound component consisting of at least one selected from
a titanium compound (1) represented by the following general formula (I), and
a titanium compound (2) obtained by reaction of the titanium compound (1) of the general formula (I) and an aromatic polyvalent carboxylic acid represented by the following general formula (II), or its anhydride: 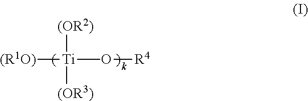
wherein R¹, R², R³ and R⁴ in the formula (I) each mutually independently represent an alkyl group having 2 to 10 carbon atoms, k represents an integer of 1 to 3, and when k represents 2 or 3, two or three R² groups and R³ groups are each optionally mutually the same or different, 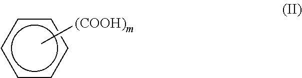
wherein m in the formula (II) represents an integer of 2 to 4;
(B) a phosphorus compound component consisting of at least one phosphorus compound (3) represented by the following general formula (III): 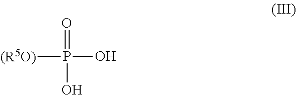
wherein R⁵ in the formula (III) represents an unsubstituted or substituted, aryl group having 6 to 20 carbon atoms or alkyl group having 1 to 20 carbon atoms.

2. The catalyst particle for polyester production according to claim 1, wherein a reaction molar ratio (m_{Ti}/m_{P}) of a molar amount in terms of titanium atom (m_{Ti}) of the titanium compound component (A) to a molar amount in terms of phosphorus atom (m_{P}) of the phosphorus compound component (B), in the reaction product of the titanium compound component (A) and the phosphorus compound component (B), is in the range from 1:1 to 1:3.

3. The catalyst particle for polyester production according to claim 1, wherein the titanium compound (1) of the formula (I) is selected from a titanium tetra-alkoxide compound, an octaalkyl trititanate compound, and a hexaalkyl dititanate compound.

4. The catalyst particle for polyester production according to claim 1, wherein the aromatic polyvalent carboxylic acid of the formula (II), or its anhydride is selected from phthalic acid, trimellitic acid, hemimellitic acid, and pyromellitic acid, or their anhydrides.

5. The catalyst particle for polyester production according to claim 1, wherein the titanium compound (2) is a reaction product of the titanium compound (1) of the formula (I) and the aromatic polyvalent carboxylic acid of the formula (II), or its anhydride, at a reaction molar ratio of 2:1 to 2:5.

6. The catalyst particle for polyester production according to claim 1, wherein the phosphorus compound (3) of the formula (III) is at least one selected from the group consisting of monomethyl phosphate, monoethyl phosphate, monotrimethyl phosphate, mono-n-butyl phosphate, monohexyl phosphate, monoheptyl phosphate, monooctyl phosphate, monononyl phosphate, monodecyl phosphate, monododecyl phosphate, monolauryl phosphate, monooleyl phosphate, monotetradecyl phosphate, monophenyl phosphate, monobenzyl phosphate, mono(4-dodecyl)phenyl phosphate, mono(4-methylphenyl)phosphate, mono(4-ethylphenyl)phosphate, mono(4-propylphenyl)phosphate, mono(4-dodecylphenyl)phosphate, monotolyl phosphate, monoxylyl phosphate, monobiphenyl phosphate, mononaphthyl phosphate, and monoanthryl phosphate.

7. The catalyst particle for polyester production according to claim 1, comprising a reaction product of a titanium compound component (A) including at least one titanium compound of the formula (I) (wherein k represents 1) and a phosphorus compound component (B) including at least one phosphorus compound (3) of the formula (III).

8. The catalyst particle for polyester production according to claim 7, wherein the reaction product of a titanium compound component (A) including at least one titanium compound of the formula (I) (wherein k represents 1) and a phosphorus compound component (B) including at least one phosphorus compound (3) of the formula (III) comprises a compound represented by the following formula (IV): 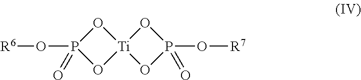
wherein R⁶ and R⁷ each mutually independently represent an alkyl group having 2 to 10 carbon atoms or an aryl group having 6 to 12 carbon atoms.

9. The catalyst particle for polyester production according to claim 1, wherein the reaction product of the titanium compound component (A) and the phosphorus compound component (B) is generated at a reaction starting temperature of 25 to 35° C. and at a reaction temperature of 50 to 200° C.

10. A method for producing a polyester, comprising subjecting a polymerization starting material consisting of at least one selected from an ester of an aromatic dicarboxylic acid and an alkylene glycol, and its low polymer, to polycondensation reaction in the presence of the catalyst particle for polyester production according to claim 1.

11. The method for producing a polyester according to claim 10, wherein a millimolar amount of a titanium atom contained in the catalyst particle is 2 to 40% based on a total millimolar amount of the aromatic dicarboxylic acid component contained in the polymerization starting material.

12. The method for producing a polyester according to claim 10, wherein the aromatic dicarboxylic acid is selected from terephthalic acid, isophthalic acid, naphthalenedicarboxylic acid, diphenyldicarboxylic acid, diphenyl sulfonedicarboxylic acid, diphenylmethanedicarboxylic acid, diphenyl ether dicarboxylic acid, diphenoxyethanedicarboxylic acid, and β-hydroxyethoxybenzoic acid.

13. The method for producing a polyester according to claim 12, wherein the terephthalic acid is obtained by depolymerization of polyalkylene terephthalate and hydrolysis of dimethyl terephthalate thus obtained.

14. The method for producing a polyester according to claim 10, wherein the ester of the aromatic dicarboxylic acid and the alkylene glycol is an ester of terephthalic acid and an alkylene glycol, and is obtained by depolymerization of polyalkylene terephthalate and transesterification reaction of dimethyl terephthalate thus obtained and an alkylene glycol.

15. The method for producing a polyester according to claim 13, wherein the polyalkylene terephthalate to be subjected to depolymerization is a polyalkylene terephthalate molded product disposed of and/or a polymer scrap recovered in a production process of polyalkylene terephthalate.

16. The method for producing a polyester according to claim 10, wherein the alkylene glycol is selected from ethylene glycol, trimethylene glycol, tetramethylene glycol, neopentyl glycol, and hexamethylene glycol.

17. The method for producing a polyester according to claim 10, wherein the polycondensation reaction is performed at a temperature of 230 to 320° C.

18. A polyester produced by the method according to claim 10.

19. The polyester according to claim 18, having an intrinsic viscosity of 0.30 to 0.90, wherein
a content of a cyclic trimer in the ester of the aromatic dicarboxylic acid and the alkylene glycol is 0.50% by mass or less, and
a content of acetaldehyde is 5 ppm or less.

20. The polyester according to claim 18, wherein an antioxidant comprising at least one hindered phenol compound is contained at a content of 1% by mass or less based on a mass of the polyester.

21. A molded article comprising the polyester according to claim 18.

22. The molded article according to claim 21, selected from a bottle-shaped product, a sheet-shaped product, a thermally molded container, and an injection molded article.

23. A polyester fiber obtained by melting a resin raw material comprising the polyester according to claim 18, and extruding this molten body into a fiber and solidifying the fiber.

24. A polyester film obtained by melting a resin raw material comprising the polyester according to claim 18, extruding this molten body into a sheet and solidifying the sheet, and stretching an unstretched film obtained, in a biaxial direction.
